(19) United States
(12) Patent Application Publication
(10) Pub. No.: US 2025/0278614 A1
(43) Pub. Date: Sep. 4, 2025

(54) RAPID AND UNCERTAINTY QUANTIFIED ORBITAL PROPAGATION USING UNCERTAINTY-AWARE ARTIFICIAL INTELLIGENCE

(71) Applicant: RTX BBN Technologies, Inc., Cambridge, MA (US)

(72) Inventors: Kevin Michael Vanslette, Mendon, MA (US); Alexander Wilmot Lay, Arlington, VA (US)

(21) Appl. No.: 19/066,621

(22) Filed: Feb. 28, 2025

Related U.S. Application Data
(60) Provisional application No. 63/559,590, filed on Feb. 29, 2024.

(51) Int. Cl. G06N 3/049

(52) U.S. Cl. CPC G06N 3/049

(57) ABSTRACT

A method includes processing, by a neural network, trajectory data associated with an object. The method includes generating, based on processing the trajectory data by the neural network, predicted trajectory information associated with the object and an uncertainty associated with the predicted trajectory information.

### CROSS-REFERENCE TO RELATED APPLICATIONS

This application claims the benefit of U.S. Application No. 63/559,590 filed Feb. 29, 2024, the disclosure of which is incorporated herein by reference in its entirety.

### BACKGROUND

The present disclosure relates to orbital propagation and, in particular, to rapid and uncertainty quantified orbital propagation using uncertainty-aware (UA) artificial intelligence (AI).

Due to the proliferation of resident space objects (RSOs) in low earth orbit (LEO), the task of real-time orbital tracking and propagation over the entire LEO belt is computationally expensive using traditional physics-based methods. Some physics-based methods may be used for propagation and tracking due to their high fidelity, reliability, explainability, control and maneuver modeling, and their ability to quantify and forecast track uncertainty. Due to the nonlinearity of orbital dynamics, a primary computational expense comes from accurately approximating the propagation of track uncertainty. Common methods, such as the unscented or particle Kalman Filter, may be reliant on repeated sampling of the propagator, which is only partially parallelizable. Further, once new observations are obtained, track and uncertainty forecasts may need to be repropagated when using such methods.

### BRIEF DESCRIPTION

Disclosed is a technique for rapid and uncertainty quantified orbital propagation using uncertainty-aware (UA) deep neural networks. This propagation method may provide results which are far faster than real-time and enable scalable higher-level track forecasting analysis such as, for example, maneuver detection, observation correlation, multi-hypothesis and counterfactual forecasting, sensor scheduling, and conjunction screening at unprecedented scales. The techniques described herein leverage advances in UA artificial intelligence (AI) to reliably predict accurate tracks and multi-time track covariance matrices from high fidelity simulation data of both “expected inlier” and “unexpected outlier” track scenarios.

Example embodiments of the present disclosure are directed to a method including: processing, by a neural network, trajectory data associated with an object; and generating, based on processing the trajectory data by the neural network: predicted trajectory information associated with the object; and an uncertainty associated with the predicted trajectory information.

In any one or combination of the embodiments disclosed herein, the predicted trajectory information and the uncertainty are generated by one or more uncertainty-aware artificial intelligence models included in the neural network.

In any one or combination of the embodiments disclosed herein, generating the uncertainty is based on predicting, by a prediction model included in the neural network: a mean ephemeris value associated with the object, with respect to each temporal instance included among multiple temporal instances; and a covariance of the mean ephemeris values.

In any one or combination of the embodiments disclosed herein, generating the uncertainty is based on: predicting, by each prediction model of a set of prediction models included in the neural network: a mean ephemeris value associated with the object, with respect to each temporal instance included among multiple temporal instances; and a covariance of the mean ephemeris values; calculating a mean predicted covariance based on the predicted covariances respectively provided by the set of prediction models; and calculating a covariance of the predicted means.

In any one or combination of the embodiments disclosed herein, the trajectory data includes simulated trajectory data of an object.

In any one or combination of the embodiments disclosed herein, the trajectory data includes a simulated orbital trajectory of the object with reference to another object.

Example embodiments of the present disclosure are directed to a system configured to: process, by a neural network, trajectory data associated with an object; and generate, based on processing the trajectory data by the neural network: predicted trajectory information associated with the object; and an uncertainty associated with the predicted trajectory information.

In any one or combination of the embodiments disclosed herein, the predicted trajectory information and the uncertainty are generated by one or more uncertainty-aware artificial intelligence models included in the neural network.

In any one or combination of the embodiments disclosed herein, the system is configured to generate the uncertainty based on predicting, by a prediction model included in the neural network: a mean ephemeris value associated with the object, with respect to each temporal instance included among multiple temporal instances; and a covariance of the mean ephemeris values.

In any one or combination of the embodiments disclosed herein, the system is configured to generate the uncertainty based on: predicting, by each prediction model of a set of prediction models included in the neural network: a mean ephemeris value associated with the object, with respect to each temporal instance included among multiple temporal instances; and a covariance of the mean ephemeris values; calculating a mean predicted covariance based on the predicted covariances respectively provided by the set of prediction models; and calculating a covariance of the predicted means.

In any one or combination of the embodiments disclosed herein, the trajectory data includes simulated trajectory data of an object.

In any one or combination of the embodiments disclosed herein, the trajectory data includes a simulated orbital trajectory of the object with reference to another object.

Example embodiments of the present disclosure are directed to an apparatus including: a memory having computer readable instructions and one or more processors for executing the computer readable instructions, wherein the computer readable instructions, when executed by the one or more processors, cause the apparatus to: process, by a neural network, trajectory data associated with an object; and generate, based on processing the trajectory data by the neural network: predicted trajectory information associated with the object; and an uncertainty associated with the predicted trajectory information.

In any one or combination of the embodiments disclosed herein, the predicted trajectory information and the uncertainty are generated by one or more uncertainty-aware artificial intelligence models included in the neural network.

In any one or combination of the embodiments disclosed herein, the apparatus is configured to generate the uncertainty based on predicting, by a prediction model included in the neural network: a mean ephemeris value associated with the object, with respect to each temporal instance included among multiple temporal instances; and a covariance of the mean ephemeris values.

In any one or combination of the embodiments disclosed herein, the apparatus is configured to generate the uncertainty based on: predicting, by each prediction model of a set of prediction models included in the neural network: a mean ephemeris value associated with the object, with respect to each temporal instance included among multiple temporal instances; and a covariance of the mean ephemeris values; calculating a mean predicted covariance based on the predicted covariances respectively provided by the set of prediction models; and calculating a covariance of the predicted means.

In any one or combination of the embodiments disclosed herein, the trajectory data includes simulated trajectory data of an object.

In any one or combination of the embodiments disclosed herein, the trajectory data includes a simulated orbital trajectory of the object with reference to another object.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example of a system that supports rapid and uncertainty quantified orbital propagation using UA-AI in accordance with one or more embodiments of the present disclosure.

FIG. 2 illustrates aspects of the trajectory data of FIG. 1 and described training data, based on which the UA-AI techniques described herein may be used in solving the problem of ephemeris forecasting in LEO.

FIG. 3 through FIG. 5 illustrate aspects of UA-AI approaches and UA-AI models that support rapid and uncertainty quantified orbital propagation using UA-AI in accordance with one or more embodiments of the present disclosure.

FIG. 6 illustrates an example of a conjunction event in which two RSOs are close to one another and for which the systems and techniques described herein support rapid screening using UA-AI.

FIG. 7 is a block diagram of a distributed computer system, in which various aspects and functions discussed herein may be practiced.

FIG. 8 illustrates an example flowchart of a method in accordance with one or more embodiments of the present disclosure.

### DETAILED DESCRIPTION

A detailed description of one or more embodiments of the disclosed apparatus and method are presented herein by way of exemplification and not limitation with reference to the Figures.

Due to the proliferation of Resident Space Objects (RSOs) in Low Earth Orbit (LEO), the task of real-time orbital tracking and propagation over the entire LEO belt is computationally expensive using traditional physics-based methods. Physics-based methods are used for propagation and tracking due to their high fidelity, reliability, explainability, control and maneuver modeling, and their ability to quantify and forecast track uncertainty. Due to the nonlinearity of orbital dynamics, a primary computational expense comes from accurately approximating the propagation of track uncertainty. Common methods, such as the unscented or particle Kalman Filter, may be reliant on repeated sampling of the propagator, which is only partially parallelizable. Further, once new observations are obtained, track and uncertainty forecasts need to be repropagated when using such methods.

Despite producing state-of-the-art results in terms of prediction accuracy, traditional deep learning AI methods can still fail to meet the high reliability and robustness standards that would allow for their adoption into critical space domain applications. This is to say, it is not good enough for a model to make accurate predictions over “inlier” training and testing datasets if the model then fails to generalize appropriately in real world applications that may include “outliers.” If new data is sufficiently different from the data used to train the model, i.e. outlier data, traditional AI methods often make overly confident, yet incorrect, predictions. This is a major problem for space applications because not only is the prediction wrong, but the prediction is wrong without warning of possible errors, which could compromise the integrity of downstream processing and decision making.

Outlier situations arise when applying an AI model outside of the domain of the training data. This problem can be readily observed by training on one orbit but testing on another, training on station keeping maneuvers but testing on large maneuvers, or training on low-fidelity simulation data but testing on real data.

Embodiments of the present disclosure provide an AI model which is trained to produce properly quantified predictive uncertainties (i.e. orbital uncertainties), while also being able to handle outlier situations by stating it “doesn't know” through the prediction of large uncertainties. The techniques described herein include providing such predictions of large uncertainties to downstream processes and decision makers, thereby using such predictions to “tip-off” downstream processes and decision makers to defer to other models (such as traditional physics-based models) to ensure the robustness of the application. The subfield of AI that aims to get AI to accurately predict its own uncertainty is called uncertainty-aware, or probabilistic.

In accordance with one or more embodiments of the present disclosure, to combat scalability challenges that arise when trying to track and propagate RSOs in LEO, an uncertainty-aware deep neural network approach is provided that forecasts both orbital trajectories and their corresponding joint covariance matrices over the trajectory's joint multi-time configuration space. This approach has distinct advantages over traditional physics-based orbital propagation. First, in desktop experiments and only using the CPU, this approach yields a greater than 1000 times speed-up in terms of the number of propagations per second over other leading open-source physics-based propagation tools (applied to 40,000 simulated RSOs in LEO) such as, for example, Orekit. Because the method disclosed herein forecasts trajectories and covariance in the joint configuration space, a second advantage is that updating forecasted tracks with new observations (or counterfactual conditions) may be implemented by updating the joint multi-time mean trajectory vector and covariance matrix, which can be done in parallel across the trajectory rather than requiring serial repropagation.

On a challenging data set and for a related problem, the techniques described herein are capable of predicting accurate (error quantifying) covariance matrices within a few percentage points of the ground truth error distribution, which means the predicted heteroskedastic uncertainties from the model are well calibrated. Further, the techniques described herein may reliably predict large uncertainties in outlier situations by design, which suppresses Kalman filter track aberrations due to outliers compared to other methods.

Techniques described herein of training an uncertainty-aware AI model may include using the REsponsive Space ObservatioN Analysis and Autonomous Tasking Engine (RESONAATE), which has a higher fidelity than Orekit. The techniques described herein may include using RESONAATE to generate high fidelity physics-based orbital track data and uncertainties with station keeping maneuvers for training and testing. The techniques described herein include training AI models (e.g., UA-AI models described herein) using the same input parameters as RESONAATE such as, for example, spacecraft parameters (e.g. mass, drag coefficient, and reflectivity) and environmental parameters (e.g., solar radiation pressure, Earth procession and nutation, atmospheric drag, and gravity) as well as the prior trajectory and covariance information. The techniques described herein include applying single mode deep Gaussian ensembles as well as dynamic deep multivariate mixture ensembles to capture the non-Gaussian deviations (e.g. covariance non-realism) that may occur in the long-time propagation horizon due to the nonlinearity of the propagation dynamics. The techniques described herein provide a robustness and an ability to gracefully generalize outside of the “inlier” training station keeping data.

Further, SDA applications may have considerable functional dependence on the current and future position estimates of RSOs. At the lowest level, and due to observation intermittence, maintaining RSO orbital track estimates may enable future observations to be properly correlated with them. Forecasts of these tracks are important decision variables in higher level SDA planning applications for space traffic management, conjunction and collision avoidance, higher level data fusion analytics, and space debris cleanup planning. Any error, uncertainty, and/or latency in the production of these track forecasts may propagate to downstream SDA applications, which diminishes their utility. Modeling efforts and the application of computational resources for creating high fidelity and scalable solutions for maintaining and forecasting RSO tracks with uncertainty are desired.

For applications such as, for example, space traffic management in the LEO regime, maintaining tracks and track forecasts may enable the identification of potential conjunctions and collisions so avoidance maneuvers can be scheduled. The European Space Agency's 2024 Space Environment Report estimates there are about 34K objects greater than 10 cm in LEO and nearly 1 million objects between 1 and 10 cm, both of which can create computational challenges for space traffic management. While physics-based parametric models for tracking and propagation have long-standing and proven high fidelity, reliability, explainability, and an ability to quantify and forecast track uncertainty, the methods themselves may involve significant computational resources at this scale. For example, in some cases, implementation of physics-based parametric models at such a scale may not be feasible due to associated high overhead costs and/or a lack of computational resources. Speed (or computational complexity) and accuracy can be traded off by choosing which special perturbations to use in a given model; however, there is a significant gap in the speed-accuracy trade space between simple Keplerian motion and J2 or other special perturbations.

Alternatively, there are classes of non-parametric AI models that may be able to populate useful regions within the speed-accuracy trade space to give more modeling flexibility to practitioners. AI models move the bulk of the computational heavy lifting into offline training phases which generates models that can be evaluated quickly and with relatively low computational complexity due to Graphical Processing Unit (GPU) parallelization.

Some AI modeling approaches, while being able to make fast and accurate predictions over complex datasets, may fail to meet the high reliability and robustness standards that would allow for their adoption into critical space domain applications. In particular, in outlier scenarios, some traditional AI methods often and without warning produce overly confident, yet wrong, predictions. This is to say, it is not good enough to train models that make state-of-the-art accurate predictions over “inlier” training datasets if the model then fails to generalize appropriately in real world applications that may include “outliers.” This is a major problem for AI-based SDA applications because not only is the prediction wrong, but the AI methods may fail to provide warning of possible errors, which could compromise the integrity of downstream processing and decision making.

Outlier scenarios may arise when applying an AI model outside of the domain of the training data. Deviations from the domain of the training data may be driven dynamically by environmental non-stationary data drifts or may be due to induced scope/domain training and testing mismatches. For the problem of ephemeris propagation in LEO, the former may include things such as, for example, increased drag in LEO due to solar maximum (11 year cycle), and the latter may include expecting training a model on one orbital regime to generalize to another or expecting models trained on low fidelity simulators to accurately reflect reality when testing on real data.

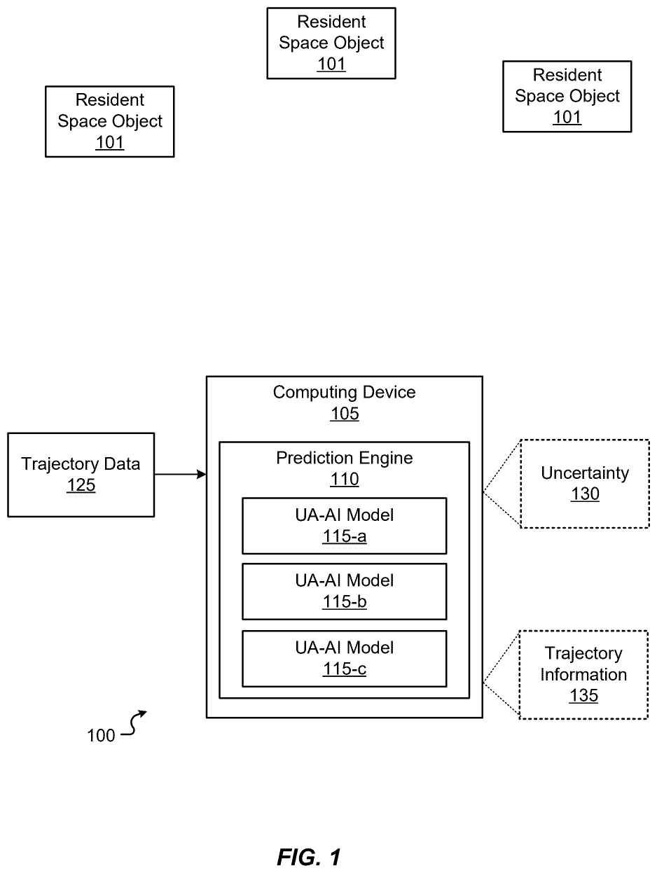

FIG. 1 illustrates an example of a system 100 that supports rapid and uncertainty quantified orbital propagation using UA-AI in accordance with one or more embodiments of the present disclosure.

The system 100 includes a computing device 105. In accordance with one or more embodiments of the present disclosure, the computing device 105 may process trajectory data 125 associated with a resident space object 101 and generate (i.e., predict), based on processing the trajectory data 125, trajectory information 135 associated with a resident space object 101. The trajectory information 135 may be referred to as ephemeris, ephemerides, and the like as described herein.

The trajectory data 125 may include simulated trajectory data associated with the resident space object 101. In some aspects, the trajectory data 125 may include simulated trajectory data of the resident space object 101 with reference to a reference object, but is not limited thereto. In some aspects, the reference object may be a planetary object (e.g., the Earth, the moon, or the like), a vehicle, or the like. Additionally, or alternatively, the trajectory data 125 may include actual trajectory data (e.g., observed trajectory data as reported by sensors or other tracking equipment) associated with the resident space object 101.

The prediction engine 110 may include a neural network including uncertainty-aware artificial intelligence (UA-AI) models 115 (e.g., UA-AI model 115-a, UA-AI model 115-b, and UA-AI model 115-c). The prediction engine 110 may apply any of the UA-AI models 115 in association with generating the trajectory information 135, example aspects of which are later described herein. Using the prediction engine 110, the computing device 105 may generate an uncertainty 130 associated with the trajectory information 135, example aspects of which are later described herein.

As will be described herein, embodiments of the present disclosure provide an augmented, covariance predicting, AI framework for scalable orbital propagation of resident space objects 101 in LEO. Aspects of the present disclosure include providing the relative size of the predictive covariance as an indicator of how well this “uncertainty-aware” AI approach understands the orbit of a given resident space object 101. According to embodiments of the present disclosure, in outlier situations, the computing device 105 is configured to overtly predict large amounts of uncertainty 130 rather than silently producing erroneous results.

The uncertainty 130 provided by the computing device 105 may serve as a feature supportive of robust and performant space domain awareness (SDA) applications, and particularly, low earth orbit (LEO) SDA applications. For example, the computing device 105 may provide the uncertainty 130 to down-stream decision systems (not illustrated), and based on the uncertainty 130, the down-stream decision systems may choose whether a given AI prediction (i.e., trajectory information 135) should be trusted and utilized or ignored and replaced, based on comparing the uncertainty 130 to a threshold uncertainty value. Additionally, or alternatively, the computing device 105 may determine whether to forward the trajectory information 135 to the down-stream decision systems or regenerate the trajectory information 135, based on comparing the uncertainty 130 to the threshold uncertainty value.

The models 115 described herein may be trained over a relatively small dataset. In an example implementation, using the models 115 and the techniques described herein, the computing device 105 may forecast the orbital trajectories of 34K resident space objects 101 one day into the future (e.g., 5-minute intervals) on a single GPU in 5.5 seconds with 46.6 km Root Mean Squared Error (RMSE). In some aspects, the systems and techniques described herein may provide single orbit forecasts having RMSEs as low as 5.8 km and are able to propagate 1 million ephemerides in 12.1 seconds.

The systems and techniques described herein offer practitioners a solution in the trade space between computational speed and accuracy while dynamically quantifying expected performance in terms of predicted uncertainty. Aspects of the techniques and models 115 described herein may be applied to provide effective uncertainty prediction for scalable space domain awareness.

Aspects of the models 115 are described herein incorporate UA-AI, which is a subfield of AI. UA-AI models differ from traditional AI models in that UA-AI models are trained not only to make point predictions (i.e., a mean or classification probability vector), but also to predict distributional parameters (e.g., the variance around a classification probability vector) as additional outputs from the neural network.

The models 115 described herein have been trained to learn the aleatoric (statistical) uncertainty of inlier dataset and model pair, and further, to reliably estimate their own predictive uncertainty when presented with outlier data. Other approaches supported by the present disclosure include training a small ensemble of uncertainty-aware networks (over the same data, about five (5) models 115) and probabilistically combining results of the models 115 to significantly improve uncertainty estimation in outlier data regions, which supports providing high-reliability predictions of large uncertainty. The ensemble method exploits inter-model disagreement due to the differences in the learned high dimensional model parameters. The techniques described herein apply UA-AI approaches for regression, classification, object detection, and segmentation based on these concepts. The techniques described herein apply UA-AI approaches which tackle the problem of outliers directly through predictive uncertainty.

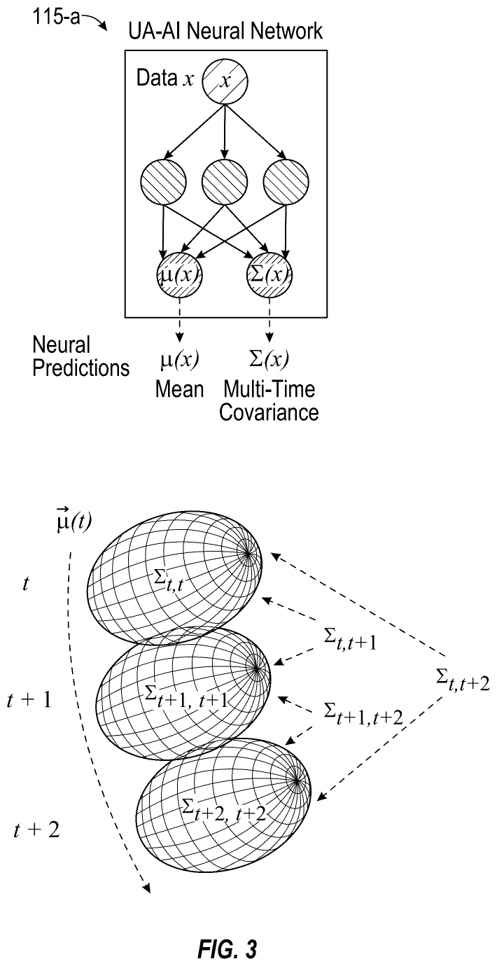

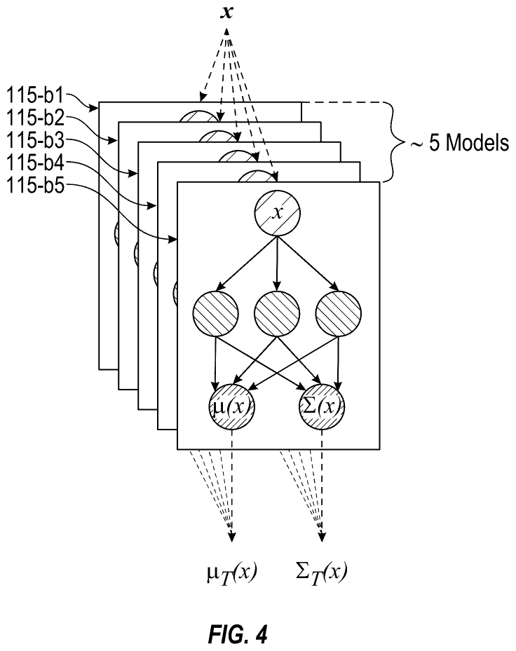

In accordance with one or more embodiments of the present disclosure, the prediction engine 110 may include a relatively small ensemble of UA-AI feed forward neural networks (with convolutional layers) which may jointly forecast entire ephemeris trajectories in a single pass, as well as multi-time covariance matrices associated with the ephemeris trajectories, example aspects of which are later described with reference to FIGS. 3 and 4. Using the UA-AI feed forward neural networks, the computing device 105 may perform various forecasting cases such as, for example, a first forecasting case of predicting ephemeris up to 100 minutes ahead (“single orbit”) and a second forecasting case of predicting ephemeris up to 1 day ahead along with associated covariance matrices.

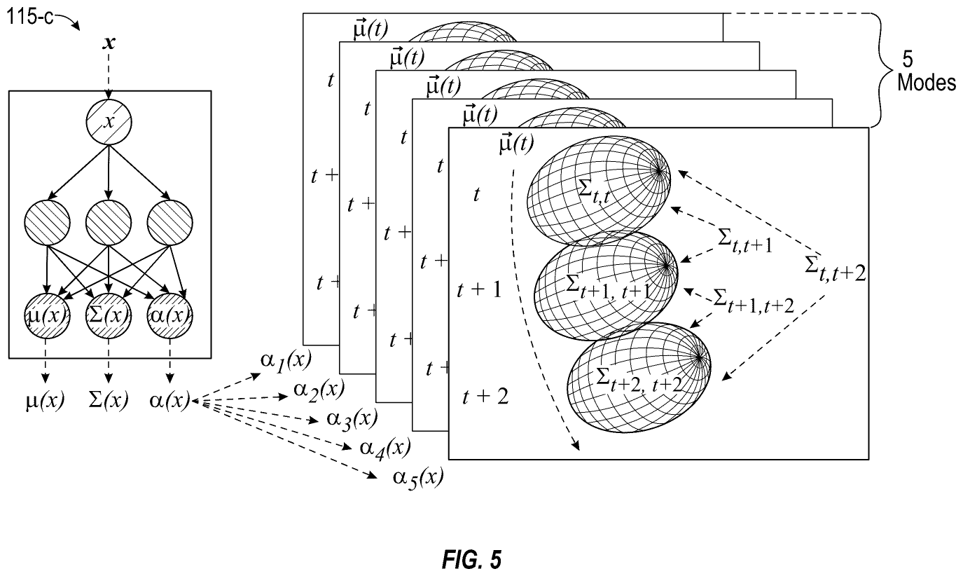

In accordance with one or more embodiments of the present disclosure, the computing device 105 may include a multi-modal multivariate Gaussian mixture model, example aspects of which are later described with reference to FIG. 5, which alone may be less robust to outliers compared to an ensemble of unimodal Gaussian mixtures but provide different benefits in exchange.

The term covariance may refer to a measure of how two variables change together. The term covariance matrix may refer to a matrix that contains covariances between variables in a time series. The term multi-time covariance may refer to a term for measuring how variables in a time series relate to each other and change over time. The term ephemeris value may refer to a calculated position or velocity of an object in space at a specific time. The term ephemeris may refer to a book with tables that gives the trajectory of naturally occurring astronomical objects and artificial satellites in the sky, i.e., the position, velocity, or the like, over time.

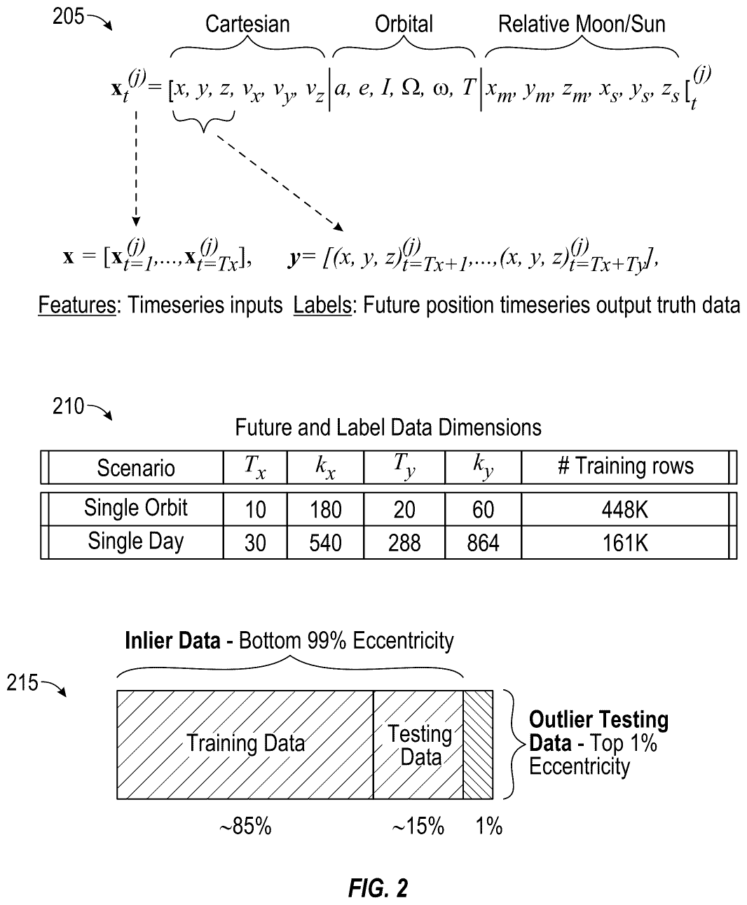

FIG. 2 illustrates aspects of the trajectory data 125 of FIG. 1 and described training data, based on which the UA-AI techniques described herein may be used in solving the problem of ephemeris forecasting in LEO.

In the example, the trajectory data 125 is a dataset including the ephemerides of about 19K resident space objects 101 simulated over a 3 day period (5 minute intervals), generated using a high fidelity numerical propagator. For example, the dataset may include LEO ephemeris data generated using extracted components of VTNSI's REsponsive Space ObservatioN Analysis and Autonomous Tasking Engine (RESONAATE), but is not limited thereto.

In an example, the trajectory data 125 includes coordinates 205 including, but not limited to, cartesian position and velocity, their complementary orbital elements, and relative positions from the resident space objects 101 to the Moon and Sun.

An example simulation scope of the trajectory data 125 is as follows: 19K RSOs, Special Perturbations, Runge-Kutta. 3 days of ephemerides @5 minute intervals. Moon and Sun 3rd body perturbations. EGM96 geopotential model truncated a degree and order 4. Coordinates 205 include Cartesian, Orbital, and Relative Moon and Sun.

Table 210 illustrates examples of feature and label data dimensions with respect to dataset included in the trajectory data 125.

An example of hardware and time associated with processing the trajectory data 125 is as follows: 4.8K RSOs distributed per HPC node. 32 CPU cores, 64 threads, at 3.4 GHz per node. 4.6 days runtime. Embodiments of the present disclosure may include partially optimizing hardware or software relatively with respect to task scale.

Graph 215 illustrates an example of inlier data (including training data and testing data) and outlier testing data.

Embodiments of the present disclosure support exploring performance gains and losses of predicting fully specified multi-time covariance matrices vs block diagonal covariance matrices that have no inter-time correlations modelled. The techniques described herein provide a robustness against outliers, as in some embodiments, the models 115 applied herein are trained on ephemeris with small eccentricity and tested on ephemeris with the largest eccentricity (i.e., outlier testing data) in a training dataset.

FIG. 3 through FIG. 5 illustrate aspects of UA-AI approaches and UA-AI models 115 that support rapid and uncertainty quantified orbital propagation using UA-AI in accordance with one or more embodiments of the present disclosure. Example aspects of uncertainty 130 and trajectory information 135 which may be determined by the computing device 105 and the prediction engine 110 are described with reference to FIG. 3 through FIG. 5.

The UA-AI approaches described herein support effective ephemeris forecasting by treating the problem as a multi-dimensional regression problem with fixed input and output sizes rather than as a sequential timeseries problem using recurrent neural networks (RNNs) or long-short term memory (LSTM) models. The proposed UA-AI approaches provide a multi-dimensional regression method having fixed input and output sizes, but make predictions in parallel across the ephemeris, increasing speed. The UA-AI approaches described herein overcome problems associated with physics-based solutions in this domain, as such physics-based solutions are sequential in nature, which results in error profiles that grow nonlinearly in the number of propagation steps. Further, the sequential nature of such physics-based approaches suffer from computational bottlenecks that involve completing the computations associated with each previous step before the next step can be computed.

With reference to FIG. 3, the UA-AI model 115-a may be capable of determining ephemeris mean and covariance. The UA-AI model 115-a may also be referred to herein as a ephemeris mean and covariance (Gaussian) model or a deep multivariate Gaussian model.

The UA-AI model 115-a may parametrically model ephemeris uncertainty using a heteroskedastic multivariate Gaussian distribution. The neural network predicts multi-time mean and covariance given input data x, as illustrated by the following Equation (1):

$$( 1 )$$

$$ρ ( y \vert μ ( x ) , \sum ( x ) ) = \frac{1}{\sqrt{{( 2 π )}^{{k}_{y}} \vert \sum ( x ) \vert}} exp ( - \frac{1}{2} {( y - μ ( x ) )}^{T} \sum {( x )}^{- 1} ( y - μ ( x ) ) )$$

The UA-AI model 115-a as trained may minimize the negative log likelihood, as illustrated by the following Equation (2):

$$\begin{matrix}( x , y ) = - ln ( ρ ( y \vert μ ( x ) , \sum ( x ) ) ) \\ = \frac{1}{2} {( y - μ ( x ) )}^{T} \sum {( x )}^{- 1} ( y - μ ( x ) ) + \frac{1}{2} ln ( \vert \sum ( x ) \vert ) + const . ,\end{matrix} \qquad ( 2 )$$

Aspects of the UA-AI model 115-a address practical challenges such as, for example: matrix inversion and the determinant (Det) (i.e., |Σ(x)|) is not numerically stable in high dimensions, matrix inversion is inefficient in high dimensions, and large domain (±10,000 km) with high precision desire (1 km), as illustrated by the following Equation (3) (i.e., positive lower triangular Cholesky matrices):

$$\sum {( x )}^{- 1} = L ( x ) {L ( x )}^{T} , \qquad ( 3 )$$

and the following Equation (4):

$$( x , y ) = \frac{1}{2} {( y - μ ( x ) )}^{T} ( L ( x ) {L ( x )}^{T} ) ( y - μ ( x ) ) - {\sum }_{i = 1}^{{k}_{y}} ln ( {L}_{ii} ( x ) ) + const . \qquad ( 4 )$$

In providing the UA-AI model 115-a, embodiments of the present disclosure include training both “fully populated” and “block diagonal” covariance matrices. Block diagonal model reduces the number of covariance elements per prediction from 373,680 to 1,728 for the single day prediction model.

Further aspects of the UA-AI model 115-a (deep multivariate Gaussian model) are now described herein.

Let a sample of input feature data (past multi-dimensional window of orbital data) be represented by a kₓ dimensional vector×∈R^{kx} and its corresponding label (future multi-dimensional window of positional ephemeris) be represented by a k_{y} dimensional vector y∈R^{ky}. A deep multivariate Gaussian distribution is modeled by using Equation (1) previously described above:

$$ρ ( y \vert μ ( x ) , Σ ( x ) ) = \frac{1}{\sqrt{{( 2 π )}^{{k}_{y}} \vert Σ ( x ) \vert}} exp ( - \frac{1}{2} {( y - μ ( x ) )}^{T} {Σ ( x )}^{- 1} ( y - μ ( x ) ) ) , \qquad ( 1 )$$

where μ(x) is μ: R^{kx}→R^{ky} and Σ(x) is Σ: R^{kx}→R^{ky×ky} are outputs from a neural network.

The techniques described herein include treating data (x,y) as a completely certain quantity, and the mean and covariance parametrically model the expected uncertainty, or error, in the neural prediction as a multivariate Gaussian. The neural network is trained to minimize the negative log likelihood, using Equation (2) previously described above:

$$\begin{matrix}= - ln ( ρ ( y \vert μ ( x ) , Σ ( x ) ) ) \\ = \frac{1}{2} {( y - μ ( x ) )}^{T} {Σ ( x )}^{- 1} ( y - μ ( x ) ) + \frac{1}{2} ln ( \vert Σ ( x ) \vert ) + const\end{matrix} , \qquad ( 2 )$$

which is averaged over batches of data samples. The covariance matrix Σ(x) is forced to be symmetric positive definite through Cholesky decomposition, using Equation (3) previously described above:

$${Σ ( x )}^{- 1} = L ( x ) {L ( x )}^{T} , \qquad ( 3 )$$

where L(x) is a real positive lower triangular matrix, which is guaranteed through the choice of positive activation functions along the diagonal elements of L. It should be noted that the predictive covariance in this case represents the uncertainty by the UA-AI model 115-a in its prediction of the ephemeris (most similar to a quantification of expected error) and is not equal to the process noise driven state covariance matrices that would be generated as part of a Kalman Filter paradigm orbital propagator.

Because the data is normalized between [−1,1] prior to training and because k_{y} is relatively large in this orbital propagation problem, direct computations of the determinant and matrix inverse may not be numerically stable. This is because the computation of the determinant involves computing k_{y} products of values <1, which can become exponentially small. The techniques described herein may largely circumvent this issue by using logarithm tricks while also forcing the UA-AI model 115-a to directly predict the inverse covariance matrices, i.e., resulting in Equation (3) previously described above:

$$L ( x ) {L ( x )}^{T} ⟶ {Σ ( x )}^{- 1} = L ( x ) {L ( x )}^{T} \qquad ( 3 )$$

where L(x) is redefined to be the Cholesky decomposition of the (also symmetric positive semidefinite) inverse covariance matrix Σ(x)⁻¹ instead, for notational simplicity in all future equations.

In addition to helping with numerical stability, the approach also speeds up training time by avoiding inverse matrix evaluations and back propagation gradients. The log of the determinant of the inverse covariance is then expressed by the following Equation (5)

$$ln ( \vert {Σ}^{- 1} ( x ) \vert ) = 2 ln ( \vert L ( x ) \vert ) = 2 ln ( {{\prod }_{i = 1}}^{{k}_{y}} {L}_{ii} ( x ) ) = 2 {{\sum }_{i = 1}}^{{k}_{y}} ln ( {L}_{ii} ( x ) ) , \qquad ( 5 )$$

where Lⱼⱼ(x) is the ith diagonal element of L due to the eigenvalue product determinant relationship |L|=πᵢλᵢ and because the eigenvalues of L, λᵢ=Lⱼⱼ(x), are equal to the diagonal elements of positive lower triangular matrices.

Using these relations, and the identity ln(|Σ(x)|)=−ln(|Σ⁻¹(x)|), the negative log likelihood is cast into a more numerically stable form in terms of L, as expressed by Equation (4) previously described above:

$$( x , y ) = \frac{1}{2} {( y - μ ( x ) )}^{T} ( L ( x ) {L ( x )}^{T} ) ( y - μ ( x ) ) - {\sum }_{i = 1}^{{k}_{y}} ln ( {L}_{ii} ( x ) ) + const . \qquad ( 4 )$$

With reference to UA-AI model 115-a, a custom neural network layer is implemented which may output μ(x) and L(x) given data x or neural transformations of x →f(x) from upstream neural layers. This approach is particularly well suited when applications call for inverse covariance matrices (such as for computing Mahalanobis distances), because computing numerically stable inverses of Σ⁻¹(x) may involve using matrix exponentials and logarithms Σ(x)=exp(−ln(Σ⁻¹(x))) in extreme cases.

In accordance with one or more embodiments of the present disclosure, the techniques described herein may include performing a non-exhaustive random hyperparameter search as part of the training process of the UA-AI models 115 described herein. Table 1 below summarizes the search space:

TABLE 1
Hyperparameter Search Space

| Hyperparameter | Values |
|---|---|
| # of convolution layers | [0, 8] |
| # of filters per convolutional layer | [32, 256] |
| # of dense neural layers | [0, 15] |
| # of neurons per dense layer | [75, 1500] |
| Scale L | [1, 200] |

In some cases, because the negative log likelihood does not directly try to minimize the error between μ(x) and y, the optimization may sometimes get “lazy” in its prediction of μ(x) and use the prediction of large covariance matrices to “hide” what would be considered large predictive errors |μ(x)−y| in this domain. To combat this “laziness,” the techniques described herein include hyperparameters that scale L, which generally encouraged the optimizer to find more precise μ(x) predictions while improving negative log likelihood.

Further, the training process included searching over a few activation functions, learning rates, and batch sizes. In addition to implementing a method for predicting fully populated covariance matrices, a block diagonal covariance model is implemented using sparse tensors. As a final post processing step, covariance matrices are rescaled to reproduce mean squared errors in the training set.

With reference to FIG. 4, the UA-AI models 115-b (e.g., UA-AI model 115-b1 through UA-AI model 115-b5) may be capable of determining ensemble model predictions for outlier robustness. The UA-AI models 115-b may be referred to as an ensemble of UA-AI models for outlier robustness.

The techniques described herein may include ensembling and aggregating the predictions of UA-AI models 115-b, which may provide increased uncertainty-awareness, particularly, for example, on outlier data. In some embodiments, the prediction engine 110 may include five UA-AI models 115-b (e.g., UA-AI model 115-b1 through UA-AI model 115-b5), but embodiments of the present disclosure are not limited thereto. In some embodiments, the UA-AI models 115-b may be the same model type. In some other embodiments, the UA-AI models 115-b may be of different model types.

With reference to UA-AI models 115-b (e.g., UA-AI model 115-b1 through UA-AI model 115-b5), the ensemble mean is may be expressed by the following Equation (6):

$${μ}_{T} ( x ) = \frac{1}{G} {\sum }_{g = 1}^{G} {μ}_{g} ( x ) \qquad ( 6 )$$

The techniques described herein may include generalizing the ensemble variance to the multivariate domain using the Law of Total Covariance and applying an ensemble generalization expressed by the following Equation (7):

$$\begin{matrix}Cov [ {y}^{i} , {y}^{j} ] = E [ Cov [ {y}^{i} , {y}^{j} \vert g ] ] + Cov [ E [ {y}^{i} \vert g ] , E [ {y}^{j} \vert g ] ] \\ = {\underbrace{E [ {Σ}_{g}^{i , j} ( x ) ]}}_{inlier covariance} + {\underbrace{Cov [ {μ}_{g}^{i} ( x ) , {μ}_{g}^{j} ( x ) ]}}_{outlier covariance} ≡ {Σ}_{T} ( x )\end{matrix} \qquad ( 7 )$$

The predicted ensemble covariance is the “mean predicted covariance” plus the “covariance of the predicted means.”

Further aspects of the UA-AI models 115-b and the ensemble model predictions are now described herein. The ensemble model predictions include applying a deep ensembles approach, generalized to the multivariate domain through the construction of “ensemble covariance” via the law of total covariance. Like the law of total variance, the ensemble covariance decomposes into the inlier (learnable, aleatoric) covariance and the outlier (estimated, epistemic) covariance, respectively, as illustrated with reference to Equation (7).

Here, with reference to Equations (6) and (7), the superscripts i, j are the i, jth components of y, Σ, and μ, and G is the total number of models in the ensemble. The prediction techniques use uniform 1/G ensemble member mixing, and empirically, ensembling G models (e.g., about 5 models, as illustrated by UA-AI models 115-b). In an example, with reference to the ensemble mean μ_{T}^{(x)}, as expressed at Equation (6), and the ensemble (total) covariance of Σ_{T}(x), the resultant ensemble model is a unimodal multivariate Gaussian distribution ρ(γ|μ_{T}(x),Σ_{T}(x)).

Even if the G models are trained over the same data and have the same hyperparameters, the approach (tuned weights/parameter values sets) taken by stochastic training algorithms is to randomly initialize a set of parameters. This means, with great certainty, the learned solutions may end up very far away from one another due to the very high dimensional parameter spaces of neural networks. However, in regions with sufficient training data, the training process causes the ensemble member p predictions to corroborate with one another, leading to small (co)variances of the p's. Alternatively, far outside this sufficient data region, and because the models are so far away from one another in parameter space, the ensemble members have no reason to agree with one another and tend to disagree, which leads to an increase in ensemble covariance.

With reference to FIG. 5, the UA-AI model 115-c may be referred to as a multivariate ephemeris Gaussian mixture model, a deep multivariate Gaussian mixture model, or a multivariate Gaussian mixture model.

Aspects of the UA-AI model 115-c in comparison to the ensemble approach of FIG. 4 are described herein. In comparison to the ensemble approach of FIG. 4, the UA-AI model 115-c may have M=5 modes to be predicted by the neural network, as expressed by the following Equation (8):

$$ρ ( y \vert {μ}_{1 : M} ( x ) , {Σ}_{1 : M} ( x ) , {α}_{1 : M} ( x ) ) = {{\sum }_{m = 1}}^{M} {α}_{m} ( x ) ρ ( y \vert {μ}_{m} ( x ) , {Σ}_{m} ( x ) ) \qquad ( 8 )$$

Minimizing the negative log likelihood of this model, which can be written using the log-sum-exponential Equation (9):

$$L ( x , y , M ) = - LSE ( {1}_{′}^{} ( x , y ) , … , {M}_{′}^{} ( x , y ) ) , \qquad ( 9 )$$

where [symbol] ₘ′(x,y)=− [symbol] ₘ(x,y)+ln(αₘ(x)) is the log likelihood of the unimodal case (i.e., [symbol] ₘ′(x,y) plus the log of the mode weight (i.e., ln(αₘ|(x)) and which is numerically stable.

As illustrated at FIG. 5, predicted mode weights are normalized, as expressed by the following Equation (10):

$${\sum }_{m = 1}^{5} {α}_{m} ( x ) = 1 \qquad ( 10 )$$

Further aspects of the UA-AI model 115-c and the deep multivariate Gaussian mixture model are now described herein. As an alternative to ensembling unimodal deep multivariate Gaussian models, a deep multivariate Gaussian mixture model is considered with reference to Equation (8) above, where M is the number mixture modes and α_{i:M}(x) are positive mode weights, which normalize to 1 through the choice of an appropriate activation function.

The negative log likelihood of the deep multivariate Gaussian mixture takes the form of the log-sum-exponential (LSE) function expressed by Equation (11)

$$LES ( {z}_{1} , … , {z}_{M} ) = ln ( {Σ}_{m = 1}^{M} exp ( {z}_{m} ) ) , \qquad ( 11 )$$

which is a standard function in most scientific computing libraries and is numerically stable. The negative log likelihood of the mixture distribution is expressed by Equation (9) above.

With reference to Equation (9), [symbol] m′(x,y)=− [symbol] m(x,y)+ln(αₘ(x)) is the negative log likelihood [symbol] ₘ(x,y) of the mth mode from Equation (4), plus the log of the corresponding mode weight ln(αₘ(x)). The number of mixture modes M is a free variable in the custom neural network layer described with reference to FIG. 5, where M=1 reproduces the unimodal case from the UA-AI model 115-a (i.e., deep multivariate gaussian model) approach described with reference to FIG. 3, that is, L(x,y,M=1)= [symbol] (x,y).

The techniques described herein may include comparing model performance of UA-AI model 115-c (deep multivariate Gaussian mixture model) on outlier data to the ensemble method described with reference to UA-AI models 115-b, by computing an analogous total covariance quantity from (7), but instead replacing ensemble members with mixture modes. This “mixture total covariance” quantity is (7) given that ensemble members are replace by modes g→m and uniform ensemble averaging is replaced by mode weight averaging. For instance, the predictive mixture mean achieved by UA-AI model 115-c is expressed by the following Equation (12):

$${μ}_{T} ( x ) = {\sum }_{m = 1}^{M} {α}_{m} ( x ) {μ}_{m} ( x ) . \qquad ( 12 )$$

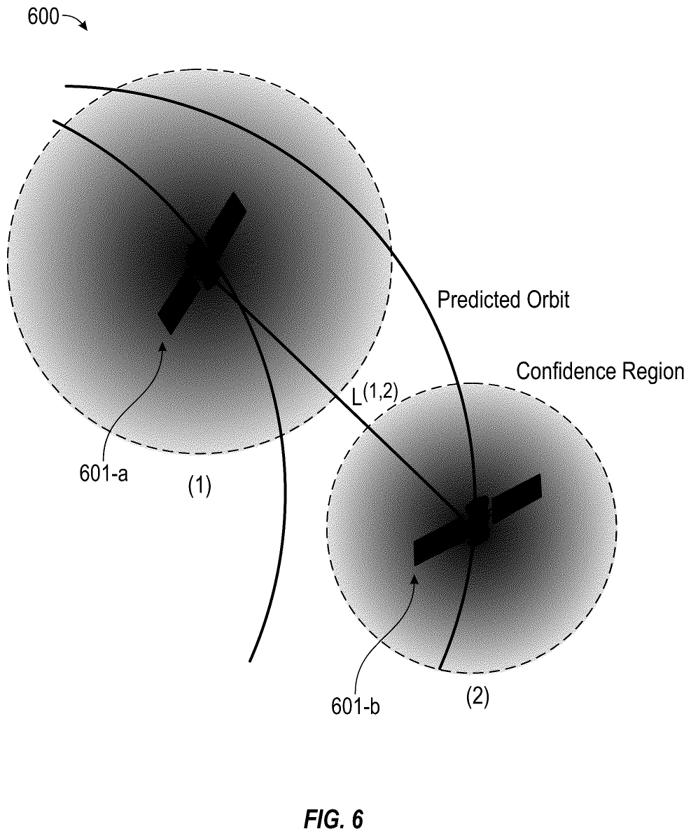

With reference to FIG. 6, the systems and techniques described herein support applying the prediction engine 110 and included any of the UA-AI models 115 to threat-based sensor tasking.

FIG. 6 illustrates an example 600 of a conjunction event in which a resident space object 601-a and a resident space object 601-b are close to one another and for which the systems and techniques described herein support rapid screening using UA-AI.

Example 600 illustrates a rare, but high risk, conjunction event in which two resident space objects 601 (e.g., resident space object 601-a, resident space object 601-b) are close to one another. The probability a conjunction occurs may be computed on the basis of the propagated mean and covariance of both resident space objects 601 using a standard calculation. In some cases, when using other approaches for determining mean and covariances, the computation may be computationally intensive when computed over all pairs of RSOs in an LEO belt (e.g., pairs drawn from ˜30,000 RSOs for multiple time steps in the future).

In contrast, an example implementation supported by the present disclosure may include applying the UA-AI techniques described herein to screen for such high risk, conjunction events. Screening using the UA-AI techniques described herein may be implemented significantly faster compared to other approaches, as the UA-AI techniques are able to produce mean and covariances faster than other approaches. Accordingly, for example, using the UA-AI techniques described herein to produce mean and covariances may support implementations which reduce the amount of time and processing overhead for computing the probability of the conjunction event.

For example, the systems and techniques described herein support optimization algorithms that rely on propagated RSO ephemeris and covariances for improved space domain awareness (e.g. space traffic management & optimal sensor tasking/scheduling).

As a further example, the techniques described herein can be used to propagate uncertainty through a Boolean definition of conjunction, as expressed by the following Equation (13):

$$ρ ( {c}^{( 1 , 2 )} ) ≡ {E}_{{\hat{L}}^{( 1 , 2 )}} [ 𝟙 ( \underline{{L}^{( 1 , 2 )} \leq } ) ] \qquad ( 13 )$$

With reference to Equation (13), probability of conjunction: inter-sat distance <threshold, which can be used to evaluate the probability two RSOs are within a given distance threshold.

The systems and techniques described herein effectively address LEO SDA Challenges in which there are many RSOs to track. For example, in 2024, the European Space Agency (2024) was tracking about 34K RSOs (each greater than 10 cm in size) and about 900K RSOs (each greater than 1 cm in size).

The systems and techniques described herein support effective SDA application performance, such as, for example, space traffic management and conjunction avoidance, which may depend on ability to quickly and accurately propagate RSO ephemeris.

The systems and techniques described herein provide improvements for limited approaches for orbital propagation in LEO (i.e. the accuracy-speed trade space is sparse). Special perturbations (e.g., J2 and others) may provide high accuracy, but numerical integration is computationally intensive at this scale for SDA applications. For example, computations may be reliant on many nodes on a high-performance computer (HPC) for faster than real-time calculations.

Simple 2-body motion calculations may be computationally efficient, but inaccurate. For example, such calculations may have gains of about 2-5% angular error per day (i.e., about 250 km-625 km). The AI-based propagations provided herein provide advantages for helping populate the accuracy-speed trade space.

The systems and techniques described herein address problems associated with other AI approaches for SDA applications. As to verification and validation, other reliability methods are intractable (e.g., Monte Carlo (MC), sensitivity analysis, or the like). For example, for a case in which High Dimensional Sparse Inputs are provided to a general AI model (e.g., 10³˜10¹⁴ model parameters), the general AI model may provide predictions over high dimensional sparse inputs, but without any predicted uncertainty. As to risk quantification, other approaches may be limited to a uniform risk profile (only test error) which is not robust to outliers. For example, 0.0001% testing error provided by a general AI model does not equate to 0.0001% chance of error per instance while deployed. Further, other AI approaches may suffer from a lack of redundancy and from risk blindness, which can lead to critical failure without warning.

In contrast, the systems and techniques described herein provide effective prediction using UA-AI models trained for accuracy and prediction uncertainty accuracy. As to verification and validation, the techniques described herein provide a focus on quantifying output uncertainty validation. As to risk quantification, the techniques described herein provide a robustness to outliers by correctly predicting large uncertainty and reporting the predicted uncertainty. For example, predicted uncertainty can be associated with severity of harm based on which to quantify risk. The systems and techniques described herein encourage the incorporation of redundancy to support risk-informed decision-making, which may prevent critical failure.

As has been described herein, the systems and techniques described herein provide models for LEO ephemeris propagation to effectively populate (e.g., with respect to speed) and reliably populate (e.g., with respect to accuracy and uncertainty) sparse speed-accuracy approach trade space. The systems and techniques described herein provide a robust uncertainty-aware AI approach capable of rapidly predicting ephemeris and heteroskedastic multi-time covariance matrices.

The techniques described herein provide inlier results with a speed and accuracy that satisfy the trade space (i.e., performance standards) associated with quantifying orbital propagation: With respect to single orbit forecasts, the systems and techniques described herein are capable of generating 1M RSO ephemerides in 12.1 s seconds, with an RMSE of 5.8 km. With respect to single day forecasts, the systems and techniques described herein are capable of generating 34 k RSO ephemerides in 5.5 s seconds, with an RMSE of 46.6 km.

The techniques described herein provide a robustness to outliers. With respect to forecasts, the single day ensemble models and single orbit ensemble models described herein reliably predict large uncertainties on outlier data in a way that is proportional to the actual RMSE.

The techniques described herein support hybrid AI and physics applications. The systems and techniques described herein support making rapid predictions with UA-AI for multiple hypothesis testing/exploration/observation correlation, space traffic management, conjunction screening, and scalable debris cleanup mission planning for reducing computational cost. Then, for example, the techniques described herein may include applying computationally intensive traditional physics models for outlier cases or identified high risk scenarios.

It is to be understood that the techniques described herein for rapid and uncertainty quantified orbital propagation using UA-AI are not limited to trajectories and orbital tracking of RSOs in LEO with respect to an object (e.g., the Earth, the Moon, etc.). The techniques described herein may similarly be applied to other orbital regimes, scalable covariance propagation estimation (e.g., particle filter/unscented Kalman filter), physics-informed regularization, and other domains such as, for example, imaging.

In accordance with one or more embodiments of the present disclosure, the UA-AI models 115 (i.e., UA-AI LEO ephemeris prediction models) provided herein are in the accuracy-speed trade space between highly accurate, but slow, special perturbation models and inaccurate, but fast, simple 2-body Keplerian motion models. Due to J2 and other perturbations in LEO, 2-body Keplerian motion models can easily pick up between 2-5 degrees of angular error over the course of a day (somewhere around 250 km-625 km).

A single day ensemble model in accordance with one or more embodiments of the present disclosure may maintain RMSEs around 45 km, and a single orbit ensemble model may maintain RMSEs around 6 km. In terms of speed, the models provided herein are able to forecast 1 million ephemerides in the LEO belt on the order of seconds or minutes rather than days or weeks.

Aspects of the present disclosure support exploring, using a hyperparameter search (of about 250 shallowly trained models) as described herein, a large set of possible UA-AI models that could be trained or designed. As an example, the choice of the number of timesteps in the input dimension may be 10 and 30 for the single orbit and single day models, respectively, but is not limited thereto. For example, aspects of the present disclosure support modifying the number of timesteps in the input dimension as applicable, so as to provide UA-AI models which may densely populate new/sparse regions in the accuracy-speed modeling trade space.

Further, embodiments of the present disclosure include tuning the amount of data for training in association with achieving a target performance. Example training sets include a 3-day dataset for about 750 RSOs, a 3-day dataset for 19,210 RSOs, and the like. With hyperparameter search, an RSME of about 60 km in a single orbit experiment was achieved with the 3-day dataset for about 750 RSOs. However, taking that model, and without changing its hyperparameters, the model reached a RMSE of about 15 km when training on the 3-day dataset for 19,210 RSOs. Embodiments of the present disclosure include balancing model performance with respect to the amount of data used for training. For example, with more data, the models may continue to improve.

In an example implementation, the techniques described herein may be applied to “quick and dirty” space traffic control/conjunction screening to rapidly rule out large swaths of infeasible conjunctions, in an uncertainty quantified manner. Alternatively, for cases of ephemeris training data which comes with heteroskedastic uncertainties, embodiments of the present disclosure include training a UA-AI model described herein such that the uncertainties are learned outright and predicted by the UA-AI model.

Embodiments of the present disclosure are not limited to trajectories and orbital tracking of RSOs in LEO with respect to an object (e.g., the Earth, the Moon, etc.). The techniques and UA-AI models 115 described herein may support providing rapid and uncertainty quantified orbital propagation on other orbital regimes or realistic, non-simulated, orbits with maneuvers. For example, the techniques described herein may be alternatively and/or additionally applied for cases in which the trajectory data 125 includes actual trajectory data (e.g., observed trajectory data) associated with an RSO.

The uncertainty-aware AI approach described herein support increased adoption of AI into SDA applications. For example, applying the predicted uncertainty measures described herein may overcome some critical limitations that prevent the wide adoption of AI into SDA applications. As the UA-AI ensemble models described herein are able to effectively and correctly identify, predict, and indicate when their performance is expected to diminish due to the presence of outliers, such information can be used to build more efficient decision systems. Such an approach would drive down computational cost and free up additional resources.

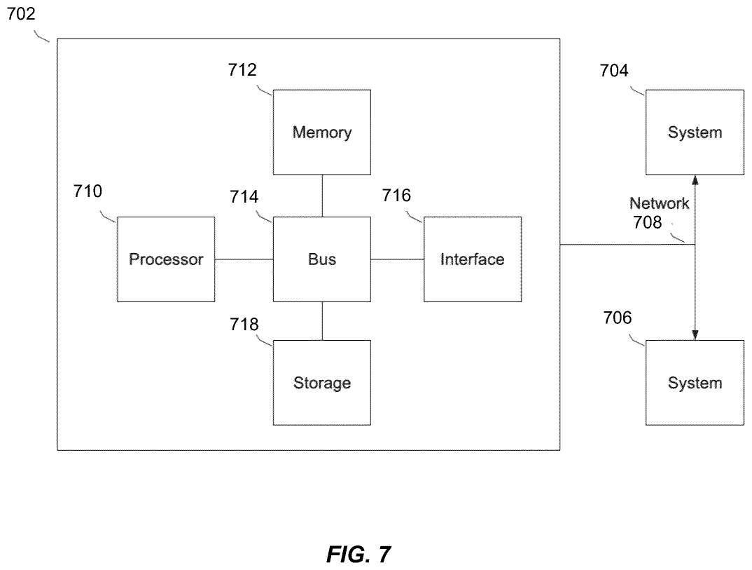

FIG. 7 is a block diagram of a distributed computer system 700, in which various aspects and functions discussed herein may be practiced. The distributed computer system 700 may include one or more computer systems. For example, as illustrated, the distributed computer system 700 includes three computer systems 702, 704 and 706. As shown, the computer systems 702, 704 and 706 are interconnected by, and may exchange data through, a communication network 708. The network 708 may include any communication network through which computer systems may exchange data. To exchange data via the network 708, the computer systems 702, 704, and 706 and the network 708 may use various methods, protocols and standards including, among others, token ring, Ethernet, Wireless Ethernet, Bluetooth, radio signaling, infra-red signaling, TCP/IP, UDP, HTTP, FTP, SNMP, SMS, MMS, SS7, JSON, XML, REST, SOAP, CORBA HOP, RMI, DCOM and Web Services.

According to some embodiments, the functions and operations discussed herein for rapid and uncertainty quantified orbital propagation using UA-AI can be executed on computer systems 702, 704 and 706 individually and/or in combination. For example, the computer systems 702, 704, and 706 support, for example, participation in a collaborative network. In one alternative, a single computer system (e.g., 702) can provide rapid and uncertainty quantified orbital propagation using UA-AI as described herein. The computer systems 702, 704 and 706 may include personal computing devices such as cellular telephones, smart phones, tablets, “fablets,” etc., and may also include desktop computers, laptop computers, etc.

Various aspects and functions in accordance with embodiments discussed herein may be implemented as specialized hardware or software executing in one or more computer systems including the computer system 702 shown in FIG. 7. In one embodiment, computer system 702 is a personal computing device specially configured to execute the processes and/or operations discussed herein. As depicted, the computer system 702 includes at least one processor 710 (e.g., a single core or a multi-core processor), a memory 712, a bus 714, input/output interfaces (e.g., 716) and storage 718 (also referred to herein as a storage system). The processor 710, which may include one or more microprocessors or other types of controllers, can perform a series of instructions that manipulate data. As shown, the processor 710 is connected to other system components, including a memory 712, by an interconnection element (e.g., the bus 714).

The memory 712 and/or storage 718 may be used for storing programs and data during operation of the computer system 702. For example, the memory 712 may be a relatively high performance, volatile, random access memory such as a dynamic random access memory (DRAM) or static memory (SRAM). In addition, the memory 712 may include any device for storing data, such as a disk drive or other non-volatile storage device, such as flash memory, solid state, or phase-change memory (PCM). In further embodiments, the functions and operations discussed with respect to rapid and uncertainty quantified orbital propagation using UA-AI can be embodied in an application that is executed on the computer system 702 from the memory 712 and/or the storage 718. For example, the application can be made available through an “app store” for download and/or purchase. Once installed or made available for execution, computer system 702 can be specially configured to execute the functions associated with rapid and uncertainty quantified orbital propagation using UA-AI.

Computer system 702 also includes one or more interfaces 716 such as input devices (e.g., camera for capturing images), output devices and combination input/output devices. The interfaces 716 may receive input, provide output, or both. The storage 718 may include a computer-readable and computer-writeable nonvolatile storage medium in which instructions are stored that define a program to be executed by the processor. The storage 718 also may include information that is recorded, on or in, the medium, and this information may be processed by the application. A medium that can be used with various embodiments may include, for example, optical disk, magnetic disk or flash memory, SSD, among others. Further, aspects and embodiments are not to a particular memory system or storage system.

In some embodiments, the computer system 702 may include an operating system that manages at least a portion of the hardware components (e.g., input/output devices, touch screens, cameras, etc.) included in computer system 702. One or more processors or controllers, such as processor 710, may execute an operating system which may be, among others, a Windows-based operating system (e.g., Windows NT, ME, XP, Vista, 7, 7, or RT) available from the Microsoft Corporation, an operating system available from Apple Computer (e.g., MAC OS, including System X), one of many Linux-based operating system distributions (for example, the Enterprise Linux operating system available from Red Hat Inc.), a Solaris operating system available from Oracle Corporation, or a UNIX operating systems available from various sources. Many other operating systems may be used, including operating systems designed for personal computing devices (e.g., iOS, Android, etc.) and embodiments are not limited to any particular operating system.

The processor and operating system together define a computing platform on which applications (e.g., “apps” available from an “app store”) may be executed. Additionally, various functions for generating and manipulating images may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed components, or any combination thereof. Various embodiments may be implemented in part as MATLAB functions, scripts, and/or batch jobs. Thus, the invention is not limited to a specific programming language and any suitable programming language could also be used.

Although the computer system 702 is shown by way of example as one type of computer system upon which various functions for rapid and uncertainty quantified orbital propagation using UA-AI may be practiced, aspects and embodiments are not limited to being implemented on the computer system, shown in FIG. 7. Various aspects and functions may be practiced on one or more computers or similar devices having different architectures or components than that shown in FIG. 7.

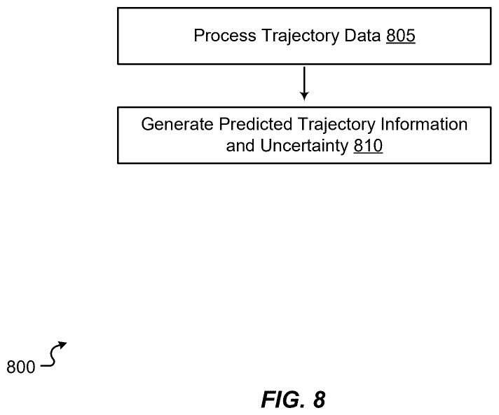

FIG. 8 illustrates an example flowchart of a method 800 in accordance with one or more embodiments of the present disclosure. The method 800 may be implemented by the example aspects of a computing device 105, a prediction engine 110, and UA-AI models 115 described herein.

At block 805, the method 800 includes processing, by a neural network, trajectory data associated with an object.

At block 810, the method 800 includes generating, based on processing the trajectory data by the neural network: predicted trajectory information associated with the object; and an uncertainty associated with the predicted trajectory information.

In some aspects, the predicted trajectory information and the uncertainty are generated by one or more uncertainty-aware artificial intelligence models included in the neural network.

In some aspects, generating the uncertainty is based on predicting, by a prediction model included in the neural network: a mean ephemeris value associated with the object, with respect to each temporal instance included among multiple temporal instances; and a covariance of the mean ephemeris values.

In some aspects, generating the uncertainty is based on: predicting, by each prediction model of a set of prediction models included in the neural network: a mean ephemeris value associated with the object, with respect to each temporal instance included among multiple temporal instances; and a covariance of the mean ephemeris values. In some aspects, generating the uncertainty is based on calculating a mean predicted covariance based on the predicted covariances respectively provided by the set of prediction models. In some aspects, generating the uncertainty is based on calculating a covariance of the predicted means.

In some aspects, the trajectory data includes simulated trajectory data of an object.

In some aspects, the trajectory data includes a simulated orbital trajectory of the object with reference to another object.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the various embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A method comprising:
processing, by a neural network, trajectory data associated with an object; and
generating, based on processing the trajectory data by the neural network:
predicted trajectory information associated with the object; and
an uncertainty associated with the predicted trajectory information.

2. The method of claim 1, wherein the predicted trajectory information and the uncertainty are generated by one or more uncertainty-aware artificial intelligence models comprised in the neural network.

3. The method of claim 1, wherein generating the uncertainty is based on predicting, by a prediction model comprised in the neural network:
a mean ephemeris value associated with the object, with respect to each temporal instance included among multiple temporal instances; and
a covariance of the mean ephemeris values.

4. The method of claim 1, wherein generating the uncertainty is based on:
predicting, by each prediction model of a set of prediction models comprised in the neural network:
a mean ephemeris value associated with the object, with respect to each temporal instance included among multiple temporal instances; and
a covariance of the mean ephemeris values;
calculating a mean predicted covariance based on the predicted covariances respectively provided by the set of prediction models; and
calculating a covariance of the predicted means.

5. The method of claim 1, wherein the trajectory data comprises simulated trajectory data of an object.

6. The method of claim 1, wherein the trajectory data comprises a simulated orbital trajectory of the object with reference to another object.

7. A system configured to:
process, by a neural network, trajectory data associated with an object; and
generate, based on processing the trajectory data by the neural network:
predicted trajectory information associated with the object; and
an uncertainty associated with the predicted trajectory information.

8. The system of claim 7, wherein the predicted trajectory information and the uncertainty are generated by one or more uncertainty-aware artificial intelligence models comprised in the neural network.

9. The system of claim 7, wherein the system is configured to generate the uncertainty based on predicting, by a prediction model comprised in the neural network:
a mean ephemeris value associated with the object, with respect to each temporal instance included among multiple temporal instances; and
a covariance of the mean ephemeris values.

10. The system of claim 7, wherein the system is configured to generate the uncertainty based on:
predicting, by each prediction model of a set of prediction models comprised in the neural network:
a mean ephemeris value associated with the object, with respect to each temporal instance included among multiple temporal instances; and
a covariance of the mean ephemeris values;
calculating a mean predicted covariance based on the predicted covariances respectively provided by the set of prediction models; and
calculating a covariance of the predicted means.

11. The system of claim 7, wherein the trajectory data comprises simulated trajectory data of an object.

12. The system of claim 7, wherein the trajectory data comprises a simulated orbital trajectory of the object with reference to another object.

13. An apparatus comprising:
a memory having computer readable instructions and one or more processors for executing the computer readable instructions, wherein the computer readable instructions, when executed by the one or more processors, cause the apparatus to:
process, by a neural network, trajectory data associated with an object; and
generate, based on processing the trajectory data by the neural network:
predicted trajectory information associated with the object; and
an uncertainty associated with the predicted trajectory information.

14. The apparatus of claim 13, wherein the predicted trajectory information and the uncertainty are generated by one or more uncertainty-aware artificial intelligence models comprised in the neural network.

15. The apparatus of claim 13, wherein the apparatus is configured to generate the uncertainty based on predicting, by a prediction model comprised in the neural network:
a mean ephemeris value associated with the object, with respect to each temporal instance included among multiple temporal instances; and
a covariance of the mean ephemeris values.

16. The apparatus of claim 13, wherein the apparatus is configured to generate the uncertainty based on:
predicting, by each prediction model of a set of prediction models comprised in the neural network:
a mean ephemeris value associated with the object, with respect to each temporal instance included among multiple temporal instances; and
a covariance of the mean ephemeris values;
calculating a mean predicted covariance based on the predicted covariances respectively provided by the set of prediction models; and
calculating a covariance of the predicted means.

17. The apparatus of claim 13, wherein the trajectory data comprises simulated trajectory data of an object.

18. The apparatus of claim 13, wherein the trajectory data comprises a simulated orbital trajectory of the object with reference to another object.
